(19) United States
(12) Patent Application Publication
(10) Pub. No.: US 2015/0134992 A1
(43) Pub. Date: May 14, 2015

(54) POWER-SAVING CIRCUIT FOR COMPUTER

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventor: LONG ZHAO, Wuhan (CN)

(21) Appl. No.: 14/535,483

(22) Filed: Nov. 7, 2014

(30) Foreign Application Priority Data
Nov. 14, 2013 (CN) 201310563955.3

(51) Int. Cl. G06F 1/32

(52) U.S. Cl. CPC G06F 1/3231; G06F 1/3234; G06F 1/3265; G06F 1/3296; G06F 1/3287
USPC 713/323; 713/320

(57) ABSTRACT

A power-saving circuit for a computer that includes a host and a monitor, the power-saving circuit includes a sensing module and a control module. The sensing module is configured to detect whether an external object in vicinity of the monitor is absent from the vicinity of the monitor, and output a corresponding detecting signal in response to detecting that the external object is absent. The control module includes a controller electronically coupled to the sensing module, the host and the monitor. The controller is configured to calculate a time period of the absence of the external object according to the detecting signal, and control the host and monitor to proceed into different power modes according to the time period.

### FIELD

The subject matter herein generally relates to power-saving circuits, and more particularly to a power-saving circuit for a computer.

### BACKGROUND

When a user stops using a host computer for a predetermined time period, the host computer will proceed into an idle state and shut off its monitor to save energy. However, when the user is using the monitor to watch videos, it is undesirable to shut off the monitor in the idle state.

### BRIEF DESCRIPTION OF THE DRAWINGS

Implementations of the present technology will now be described, by way of example only, with reference to the attached figures.

FIG. 1 is a block diagram of one embodiment of a power-saving circuit for a computer.

FIG. 2 is a circuit diagram of the power-saving circuit as shown in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” when utilized, means “including, but not necessarily limited to”; it specifically indicates open-ended inclusion or membership in the so-described combination, group, series and the like.

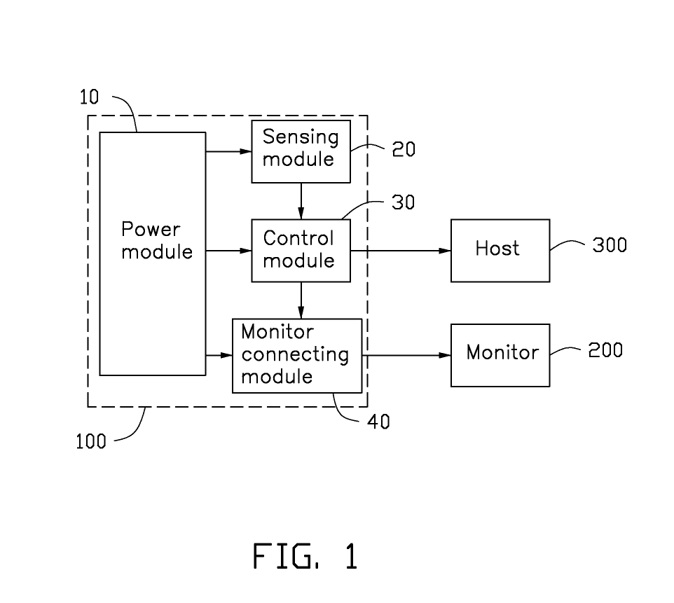

FIG. 1 illustrates a block diagram of one embodiment of a power-saving circuit 100 for a computer that has a monitor 200 and a host 300. The power-saving circuit 100 includes a power module 10, a sensing module 20 and a control module 30. The power module 10 is configured to power the sensing module 20, the control module 30 and the monitor 200. The sensing module 20 is configured to detect whether an external object in vicinity of the monitor 200 is absent from the vicinity of the monitor 200, and output a corresponding detecting signal in response to the detection. The control module 30 is electronically coupled to the sensing module 20, the host 300 and the monitor 200. The control module 30 is configured to calculate a time period of the absence of the external object according to the detecting signal, and control the host 300 and monitor 200 to proceed into different power modes according to the time period.

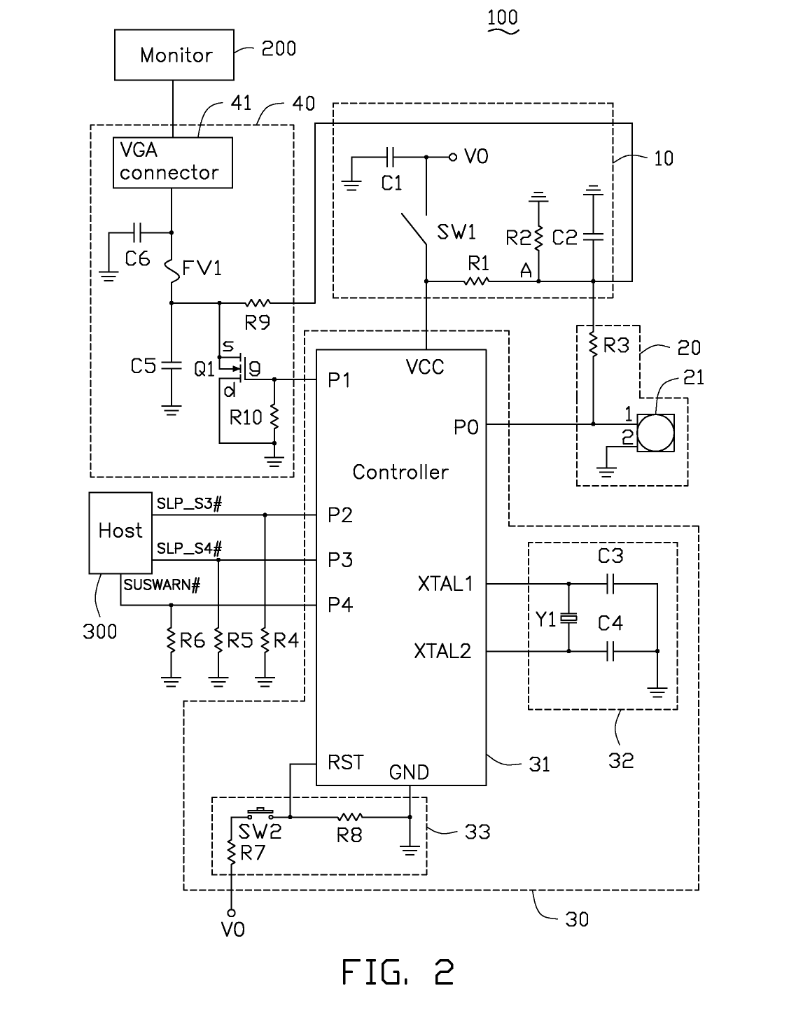

FIG. 2 illustrates a circuit diagram of the power-saving circuit 100. The control module 30 includes a controller 31. When the time period calculated by the controller 31 is longer than a first predetermined time period, the controller 31 shuts the monitor 200 off; When the time period calculated by the controller 31 is in a range from a first predetermined time period to a second predetermined time period, the controller 31 controls the host 300 to proceed into a sleep mode; when the time period is in a range from the second predetermined time period to a third predetermined time period, the controller 31 controls the host 300 to proceed into a hibernate mode; when the time period is in a range from the third predetermined time period to a fourth predetermined time period, the controller 31 controls the host 300 to proceed into a deep hibernate mode. More details will be described below.

As illustrated in FIG. 2, the power module 10 includes a power supply V0, and two voltage dividing resistors R1 and R2. The control module 30 includes the controller 31 having a power pin VCC electronically coupled to the power supply V0 and a ground pin GND that is grounded. The two voltage dividing resistors R1 and R2 are electronically coupled between the power supply V0 and ground. A node between the voltage dividing resistors R1 and R2 is defines as A that serves as a power source providing a voltage V1 lower than the power supply V0. In other words, the voltage V1 is divided from the power supply. For example, the power supply V0 is a +5 volt (V) standby power supply of the host 300, the voltage V1 is +3V.

In one embodiment, the power module 10 further includes two capacitors C1 and C2, and a power switch SW1. The power switch SW1 is electronically coupled between the power supply V0 and the power pin VCC of the controller 31. A node between the power supply V0 and the power switch SW1 is grounded via the capacitor C1. The node A is grounded via the capacitor C2. The power switch SW1 can be electronically coupled to either a power button of the host 300 or a power button of the monitor 200. When the host 300 or the monitor 200 is powered on, the power switch SW1 is switched on to activate the controller 31.

In one embodiment, the sensing module 20 includes an infrared sensor 21, and a pull-up resistor R3. The infrared sensor 21 includes an output terminal 1 and a ground terminal 2. The output terminal 1 is electronically coupled to the controller 31, a node between the output terminal 1 and the controller 31 is electronically coupled to the node A via the pull-up resistor R3. The ground terminal 2 is grounded. The infrared sensor 21 can be mounted onto the monitor 200, and is configured to detect whether an external object, such as a human body part, comes within a given distance of the monitor 200. When the infrared sensor 21 detects a presence of the external object in the vicinity of the monitor 200, the infrared sensor 21 outputs a first detecting signal to the controller 31; when the infrared sensor 21 detects the absence of the external object in the vicinity, the infrared sensor 21 outputs a second detecting signal to the controller 31, the controller 31 calculates the time period of the absence of the external object according to a time period of the second detecting signal.

As illustrated in FIG. 2, a monitor connecting module 40 (also see FIG. 1) for connecting the monitor 200 with the power supply V0 is also included. The monitor connecting module 40 includes a video graphics array (VGA) connector 41, and a transistor Q1 electronically coupled between the VGA connector 41 and the node A. The VGA connector 41 is electronically coupled to the monitor 200, thus, monitor 200 can gain power from the power supply VO via the VGA connector 41. The controller 31 is electronically coupled to the transistor Q1, and configured to control the transistor Q1 to either connect or disconnect the VGA connector 41 from the power supply VO according to the time period.

In one embodiment, the monitor 200 connecting module 40 further includes a current limiting resistor R9, a pull-down resistor R10, a fuse FV1, and two capacitors C5 and C6. The node A is electronically coupled to the VGA connector 41 via the current limiting resistor R9 and the fuse FV1. The transistor Q1 can be a field-effective transistor. The controller 31 includes a control pin P1 electronically coupled to a gate g of the transistor Q1. A drain d of the transistor Q1 is grounded, a source s of the transistor Q1 is electronically coupled to a node between the fuse FV1 and the current limiting resistor R9. The node between the fuse FV1 and the currently limiting resistor R9 is further grounded via the capacitor C5. A node between the fuse FV1 and the VGA connector is grounded via the capacitor C6. A node between the control pin P1 of controller 31 and the gate g of the transistor Q1 is grounded via the pull-down resistor R10.

The host 300 includes three suspend signal pins SLP_S3#, SLP_S4# and SUSWARN#. The controller 31 further includes three control pins P2-P4 electronically coupled to the suspend signal pins SLP_S3#, SLP_S4# and SUSWARN# respectively. A node between the control pin P2 and the suspend signal pin SLP_S3# is grounded via a pull-down resistor R4. A node between the control pin P3 and the suspend signal pin SLP_S4# is grounded via a pull-down resistor R5. A node between the control pin P4 and the suspend signal pin SUSWARN# is grounded via a pull-down resistor R6. In one embodiment, each of the suspend signal pins SLP_S3#, SLP_S4# and SUSWARN# is activated when it is pulled down to a low voltage level (such as logic 0).

The control module 30 further includes a clock circuit 32 configured to generate a clock signal to the controller 31. The clock circuit 32 includes a crystal oscillator Y1, and two capacitors C3 and C4. The controller 31 further includes two clock pins XTAL1 and XTAL2 that are grounded via the capacitors C3 and C4 respectively. The crystal oscillator Y1 is electronically coupled between the clock pins XTAL1 and XTAL2.

The control module 30 further includes a reset circuit 33 configured to reset the controller 31. The reset circuit 33 includes a reset switch SW2, a pull-up resistor R7 and a pull-down resistor R8. The controller 31 includes a reset pin RST electronically coupled to the power supply VO via the reset switch SW2 and the pull-up resistor R7. A node between the reset pin RST and the reset power switch SW1 is grounded via the pull-down resistor R8.

The working process of the power-saving circuit 100 can be carried out by, but is not limited to, the following steps. When a user powers on the host 300 or the monitor 200, the power switch SW1 is switched on to power the controller 31 and the infrared sensor 21 on. At the time the controller 31 is powered on, the controller 31 outputs a low voltage level (such as logic 0) signal to the gate g of the transistor Q1, and outputs a high voltage level (such logic 1) signal to each of the suspend signal pins SUSWARN#, SLP_S4# and SLP_S3# of the host 300 successively. At this time, the transistor Q1 is turned off to allow the monitor 200 to be powered by the power supply V0. The host 300 is at a normal work mode. When the infrared sensor 21 detects an external object is in vicinity of the monitor 200, the infrared sensor 21 outputs the first detecting signal (such as a high voltage level signal) to the controller 31, the controller 31 keeps outputting the low voltage level signal to the gate g of the transistor Q1 and the high voltage level signal to the suspend signal pins SLP_S3#, SLP_S4# and SUSWARN# of the host 300. When an absence of the external object is detected by the infrared sensor 21, the infrared sensor 21 outputs a second detecting signal (such as a low voltage level signal) to the controller 31. The controller 31 then calculates an existing time period of the second detecting single, that is, a time period of the absence of the external object. When the time period of the absence of the external object reaches a first predetermined time period, such as 1 minute, the controller 31 outputs a high voltage level signal to the gate g of the transistor Q1 to turn the transistor Q1 on, thereby proceeding the monitor 200 into a standby mode. When the time period of the absence of the external object reaches a second predetermined time period, such as 10 minutes, the controller 31 outputs a low voltage level signal to the suspend signal pin SLP_S3# of the host 300 to activate the suspend signal pin SLP_S3#, thereby proceeding the host 300 into a sleep mode. When the time period of the absence of the external object reaches a third predetermined time period, such as 30 minutes, the controller 31 outputs a low voltage level signal to the suspend signal pin SLP_S4# of the host 300 to activate the suspend signal pin SLP_S4#, thereby proceeding the host 300 into a hibernate mode. When the time period of the absence of the external object reaches a third predetermined time period, such as 60 minutes, the controller 31 outputs a low voltage level signal to the suspend signal pin SUSWARN# of the host 300 to activate the suspend signal pin SUSWARN#, thereby proceeding the host 300 into a deep hibernate mode. The sleep mode, hibernate mode, and deep hibernate mode can be defined, but is not limited to as follows.

The sleep mode—A central processing unit (CPU) of the host 300 has no power; a random access memory (RAM) of the host 300 is refreshed; the host 300 is operating in a low power mode.

The hibernate mode—The CPU has no power; the RAM is in slow refresh; the power supply is generally in a reduced power mode (for example, the power supply not supplying much power and is operating in a lower power efficiency mode, the total power dissipation is less than 5 W).

The deep hibernate mode—A hardware of the host 300 is completely off; the total power dissipation is less than 0.5 W.

As a result, since the controller 31 can control the host 300 and monitor 200 to proceed into different power modes according to an absence of a user, not only more power is saved, but also more convenience for the user.

In any time in the aforementioned working process, if the presence of an external object is detected by the infrared sensor 21 again, the infrared sensor 21 outputs the first detecting signal to the controller 31 again. The controller 31 calculates the time period of the presence of the external object, and further pull down the gate g of the transistor Q1 to low voltage level and pull up the SUSWARN#, SLP_S4# and SLP_S3# successively in condition that the time period of the presence of the external object reaches a fifth predetermined time period, such as 5 seconds. Such that the monitor 200 and the host 300 are proceed into normal work mode.

In addition, in any time in the aforementioned working process, if the reset switch SW2 is switched on, the controller 31 also proceeds the monitor 200 and the host 300 to the normal work mode by pulling down the gate g of the transistor Q1 to low voltage level and pulling up the SUSWARN#, SLP_S4# and SLP_S3# successively.

The embodiments shown and described above are only examples. Many details are often found in the art. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A power-saving circuit for a computer that comprises a host and a monitor, the power-saving circuit comprising:
a sensing module configured to detect whether an external object in vicinity of the monitor is absent from the vicinity of the monitor, and output a corresponding detecting signal in response to detecting that the external object is absent; and
a control module comprising a controller electronically coupled to the sensing module, the host and the monitor, the controller configured to calculate a time period of the absence of the external object according to the detecting signal, and control the host and monitor to proceed into different power modes according to the time period.

2. The power-saving circuit of claim 1, wherein when the time period calculated by the controller is longer than a first predetermined time period, the controller control the monitor into a standby mode; when the time period calculated by the controller is in a range from the first predetermined time period to a second predetermined time period, the controller controls the host to proceed into a sleep mode; when the time period is in a range from the second predetermined time period to a third predetermined time period, the controller controls the host to proceed into a hibernate mode; when the time period is in a range from the third predetermined time period to a fourth predetermined time period, the controller controls the host to proceed into a deep hibernate mode.

3. The power-saving circuit of claim 1, wherein the sensing module comprises an infrared sensor, a pull-up resistor, and a power source; an output terminal of the infrared sensor is electronically coupled to the controller, a node between the infrared sensor and the controller is electronically coupled to the power source via the pull-up resistor.

4. The power-saving circuit of claim 3, wherein when the infrared sensor detects a presence of the external object in the vicinity, the infrared sensor outputs a first detecting signal to the controller; when the infrared sensor detects the absence of the external object in the vicinity, the infrared sensor outputs a second detecting signal to the controller, the controller calculates the time period of the absence of the external object according to a time period of the second detecting signal.

5. The power-saving circuit of claim 2, further comprising a monitor connecting module having a video graphics array (VGA) connector, a power source, and a transistor electronically coupled between the VGA connector and the power source; wherein the VGA connector is configured to electronically couple to the monitor; the power source is configured to power the monitor via the VGA connector; the controller is electronically coupled to the transistor, and configured to control the transistor to either connect or disconnect the VGA connector from the power source according to the time period.

6. The power-saving circuit of claim 5, wherein the monitor connecting module further comprises a current limiting resistor and a pull-down resistor; the power source is electronically coupled to the VGA connector via the current limiting resistor; the transistor is a field-effective transistor, a gate of the transistor is electronically coupled to the controller, a drain of the transistor is grounded, a source of the transistor is electronically coupled to a node between the VGA connector and the current limiting resistor; a node between the controller and the gate of the transistor is grounded via the pull-down resistor.

7. The power-saving circuit of claim 6, wherein when the time period calculated by the controller is shorter than the first predetermined time period, the controller outputs a low level voltage to the transistor to turn off the transistor; wherein when the time period calculated by the controller is longer than the first predetermined time period, the controller outputs a low level signal to the transistor to turn on the transistor.

8. The power-saving circuit of claim 2, wherein the controller comprises three control pins all of which are electronically coupled to the host, nodes between control pins and the host are grounded via three pull-down resistors, respectively; the controller controls the power modes of the host by controlling the voltage level of the three control pins.

9. The power-saving circuit of claim 1, further comprising a power module, wherein the power module comprises a power supply, a first voltage dividing resistor and a second voltage dividing resistor; the controller comprises a power pin electronically coupled to the power supply; the first and second voltage dividing resistor is electronically coupled between the power supply and ground, a node between the first and second voltage dividing resistor is electronically coupled to the sensing module.

10. A power-saving circuit for a computer that comprising a host and a monitor, the power-saving circuit comprising:
a sensing module configured to detect whether an external object in vicinity of the monitor is absent from the vicinity of the monitor, and output a corresponding detecting signal in response to detecting that the external object is absent;
a control module comprising a controller electronically coupled to the sensing module, the host and the monitor, the controller configured to calculate a time period of the absence of the external object according to the detecting signal, and control the host and monitor to proceed into different power mode according to the time period; and
a power module configured to supply power to the sensing module and the control module.

11. The power-saving circuit of claim 10, wherein the power module comprises a power supply, a first voltage dividing resistor and a second voltage dividing resistor; the power supply is electronically coupled to the controller; the first and second voltage dividing resistors is electronically coupled between the power supply and ground, a node between the first and second voltage dividing resistors is electronically coupled to the sensing module.

12. The power-saving circuit of claim 11, wherein the sensing module comprises an infrared sensor and a pull-up resistor; the control module comprises a controller; an output terminal of the infrared sensor is electronically coupled to the controller, a node between the infrared sensor and the controller is electronically coupled to the node between the first and second voltage dividing resistors via the pull-up resistor.

13. The power-saving circuit of claim 11, further comprising a monitor connecting module having a video graphics array (VGA) connector, and a transistor electronically coupled between the VGA connector and the node between the first and second voltage dividing resistors; wherein the VGA connector is configured to electronically couple to the monitor; the power supply is configured to power the monitor via the VGA connector; the controller is electronically coupled to the transistor, and configured to control the transistor to either connect or disconnect the VGA connector from the power supply according to the time period.

14. The power-saving circuit of claim 13, wherein the monitor connecting module further comprises a current limiting resistor and a pull-down resistor; the power source is electronically coupled to the VGA connector via the current limiting resistor; the transistor is a field-effective transistor, a gate of the transistor is electronically coupled to the controller, a drain of the transistor is grounded, a source of the transistor is electronically coupled to a node between the VGA connector and the current limiting resistor; a node between the controller and the gate of the transistor is grounded via the pull-down resistor.

15. The power-saving circuit of claim 14, wherein when the time period calculated by the controller is shorter than a predetermined time period, the controller outputs a low level voltage to the transistor to turn off the transistor; wherein when the time period calculated by the controller is longer than a predetermined time period, the controller outputs a low level signal to the transistor to turn on the transistor.

16. The power-saving circuit of claim 10, wherein the controller comprises three control pins all of which are electronically coupled to the host, nodes between control pins and the host are grounded via three pull-down resistors, respectively; the controller controls the power modes of the host by controlling the voltage level of the three control pins.

17. The power-saving circuit of claim 16, wherein when the time period calculated by the controller is in a range from the first predetermined time period to a second predetermined time period, the controller control the host to proceed into a sleep mode; when the time period is in a range from the second predetermined time period to a third predetermined time period, the controller control the host to proceed into a hibernate mode; when the time period is in a range from the second predetermined time period to a third predetermined time period, the controller control the host to proceed into a hibernate mode; when the time period is in a range from the third predetermined time period to a fourth predetermined time period, the controller control the host to proceed into a deep hibernate mode.
